(19) United States
(12) Patent Application Publication
(10) Pub. No.: US 2026/0337347 A1
(43) Pub. Date: Oct. 29, 2026

(54) METHOD FOR PRODUCING RUBBER WET MASTERBATCH AND METHOD FOR PRODUCING RUBBER COMPOSITION

(71) Applicant: Toyo Tire Corporation, Itami-shi (JP)

(72) Inventor: Yusuke Hirao, Itami-shi (JP)

(73) Assignee: Toyo Tire Corporation, Itami-shi (JP)

(21) Appl. No.: 19/659,242

(22) Filed: Apr. 27, 2026

(30) Foreign Application Priority Data
Apr. 28, 2025 (JP) 2025-074422

(51) Int. Cl. C08J 3/22; C08K 3/04

(52) U.S. Cl. CPC C08J 3/22; C08K 3/04; C08J 2307/02

(57) ABSTRACT

A method for producing a rubber wet masterbatch using at least recycled carbon black, a dispersion solvent, and a rubber latex solution as raw materials, the method comprising:
a step (i) of dispersing the recycled carbon black in the dispersion solvent to produce a recycled carbon black slurry solution; and
a step (ii) of mixing the recycled carbon black slurry solution and the rubber latex solution to produce a recycled carbon black-containing rubber latex solution,
wherein
in the step (i), a concentration of the recycled carbon black in the dispersion solvent is set to 10 to 18 mass %, and
in the step (ii), when a total amount of the rubber solid content in the rubber latex solution is taken as 100 parts by mass, a blending amount of the recycled carbon black solid content in the recycled carbon black slurry solution is set to 35 to 60 parts by mass.

### BACKGROUND OF THE INVENTION

### Field of the Invention

The present invention relates to a method for producing a rubber wet masterbatch using at least recycled carbon black, a dispersion solvent, and a rubber latex solution as raw materials, and a method for producing a rubber composition.

### Description of the Related Art

Conventionally, in the rubber industry, it has been known to use a rubber wet masterbatch in order to improve workability and carbon black dispersibility when a carbon black-containing rubber composition is produced. In such a method, carbon black and a dispersion solvent are mixed in advance at a predetermined ratio, a carbon black-containing slurry solution in which carbon black is dispersed in a dispersion solvent by mechanical force and a rubber latex solution are mixed in a liquid phase, and then coagulated by addition of a coagulant such as an acid, and the coagulation is recovered and dried. When a rubber wet masterbatch is used, a rubber composition having better dispersibility of carbon black and better rubber physical properties such as processability and reinforcement properties is obtained as compared with a case where a rubber dry masterbatch obtained by mixing carbon black and rubber in a solid phase is used.

However, in a series of steps for producing a rubber wet masterbatch, the proportion of the dispersion solvent in a stirrer has been large, and there has been a limit to increase the production amount per batch.

For example, Patent Document 1 below describes a method for producing a wet masterbatch including a slurry preparation step of preparing a slurry solution by dispersing a filler containing recycled carbon black in water, a mixing step of mixing the slurry solution and a rubber latex solution, and a stirring step of stirring the slurry solution and the rubber latex solution after the mixing step in a liquid phase.

In addition, Patent Document 2 below describes a method for producing a wet masterbatch including a mixing and coagulation step of mixing a rubber latex with a slurry in which a filler is dispersed in water and coagulating the mixed liquid, wherein a coagulation tank for coagulating the mixed liquid is provided with a crushing blade that satisfies specific conditions, and the crushing blade is rotated at a peripheral speed of 10 m/s or more to produce a coagulum while mixing the rubber latex and the slurry.

Further, Patent Document 3 below describes a method for producing a wet masterbatch by continuously mixing and coagulating a slurry solution containing a filler and a rubber solution, wherein a coagulum is produced while the slurry solution and the rubber solution are stirred by a stirring blade provided in a coagulation tank, and the coagulum is crushed by a crushing blade provided in the coagulation tank.

### PRIOR ART DOCUMENTS

### Patent Documents

Patent Document 1: JP-B2-7467745
Patent Document 2: JP-A-2010-284799
Patent Document 3: JP-B2-5072240

### SUMMARY OF THE INVENTION

However, as a result of intensive studies by the present inventor, it has been found that the technique described in Patent Document 1 does not make a detailed study on a step of producing a rubber wet masterbatch using recycled carbon black, a dispersion solvent, and a rubber latex solution as raw materials, and the techniques described in Patent Documents 2 and 3 require special equipment such as a crushing blade that satisfies specific conditions, and there is a room for further improvement in consideration of productivity and processability.

The present invention has been made in view of the above circumstances, and an object of the present invention is to provide a method for producing a rubber wet masterbatch which is a raw material of a vulcanized rubber excellent in productivity and processability and excellent in rubber physical properties, and a method for producing a rubber composition.

The present invention relates to a method for producing a rubber wet masterbatch (1) using at least recycled carbon black, a dispersion solvent, and a rubber latex solution as raw materials, the method including:
a step (i) of dispersing the recycled carbon black in the dispersion solvent to produce a recycled carbon black slurry solution; and
a step (ii) of mixing the recycled carbon black slurry solution and the rubber latex solution to produce a recycled carbon black-containing rubber latex solution,
wherein
in the step (i), a concentration of the recycled carbon black in the dispersion solvent is set to 10 to 18 mass %, and
in the step (ii), when a total amount of the rubber solid content in the rubber latex solution is taken as 100 parts by mass, a blending amount of the recycled carbon black solid content in the recycled carbon black slurry solution is set to 35 to 60 parts by mass.

In the method for producing a rubber wet masterbatch (1), a method for producing a rubber wet masterbatch (2), wherein the step (i) is performed using a high shear mixer including a rotor including a rotating shaft and a blade, and a stator provided with a plurality of openings, is preferred.

In the method for producing a rubber wet masterbatch (2), a method for producing a rubber wet masterbatch according to (3), wherein the step (i) is a step of dispersing the recycled carbon black in the dispersion solvent using the high shear mixer by setting a clearance between the blade of the rotor and the stator to 0.1 to 0.3 mm, is preferred.

In the method for producing a rubber wet masterbatch (2) or (3), a method for producing a rubber wet masterbatch according to (4), wherein the step (i) is a step of dispersing the recycled carbon black in the dispersion solvent using the high shear mixer at a rate at which the dispersion solvent in a vessel of the high shear mixer circulates 5 to 25 times per minute for a dispersion treatment time of 10 to 50 minutes, is preferred.

In any one of the methods for producing a rubber wet masterbatch (1) to (4), a method for producing a rubber wet masterbatch (5), including, after the step (ii), a step of coagulating the recycled carbon black-containing rubber latex solution to produce a recycled carbon black-containing rubber coagulation, is preferred.

In the method for producing a rubber wet masterbatch (5), a method for producing a rubber wet masterbatch (6), including a step of finally producing a rubber wet masterbatch by dehydrating and drying the recycled carbon black-containing rubber coagulation, is preferred.

In the method for producing a rubber wet masterbatch (6), a method for producing a rubber wet masterbatch (7), including a step of finally producing a rubber wet masterbatch by dehydrating and drying the recycled carbon black-containing rubber coagulation while applying a shearing force to the recycled carbon black-containing rubber coagulation under heating to 100 to 250 °C using a single screw extruder, is preferred.

In addition, the present invention also relates to a method for producing a rubber composition (5) including mixing a rubber wet masterbatch and a compounding agent, wherein the rubber wet masterbatch is produced by any one of the methods for producing a rubber wet masterbatch (1) to (4).

According to the method for producing a rubber wet masterbatch of the present invention, it is possible to increase the production amount per batch without requiring special and large-scale facilities and while reducing the risk of occurrence of defects such as pipe clogging during slurry production. Therefore, the method for producing a rubber wet masterbatch according to the present invention is excellent in productivity and processability. Furthermore, according to the method for producing a rubber composition using the rubber wet masterbatch according to the present invention as a raw material, a rubber composition which is a raw material of a vulcanized rubber excellent in physical properties such as exothermicity and fatigue resistance can be produced.

### DETAILED DESCRIPTION OF THE PREFERRED EMBODIMENTS

The present invention relates to a method for producing a rubber wet masterbatch using recycled carbon black, a dispersion solvent, and a rubber latex solution as raw materials.

The recycled carbon black can be produced by a method known to those skilled in the art such as thermal decomposition using, for example, a rubber component of a waste tire as a raw material, and in the present invention, recycled carbon black available in the market can be used.

As the dispersion solvent, water is particularly preferably used, but for example, water containing an organic solvent may be used.

The rubber latex solution contains a diene-based rubber as a rubber component. Examples of the diene-based rubber include natural rubber, isoprene rubber, butadiene rubber, styrene butadiene rubber, acrylonitrile butadiene rubber, and butyl rubber. Among them, a natural rubber latex solution containing natural rubber as a rubber component is preferred.

Hereinafter, each step of the method for producing a rubber wet masterbatch according to the present invention will be described. The method for producing a rubber wet masterbatch according to the present invention includes: a step (i) of dispersing recycled carbon black in a dispersion solvent to produce a recycled carbon black slurry solution; and a step (ii) of mixing the recycled carbon black slurry solution and a rubber latex solution to produce a recycled carbon black-containing rubber latex solution.

<Step (i)>

In the step (i), recycled carbon black is dispersed in a dispersion solvent to produce a recycled carbon black slurry solution. In the method for producing a rubber wet masterbatch according to the present invention, the concentration of recycled carbon black in the dispersion solvent is set to 10 to 18 mass % in the step (i). This makes it possible to increase the production amount per batch while reducing the risk of occurrence of defects such as pipe clogging during slurry production. When the concentration of the recycled carbon black in the dispersion solvent is less than 10 mass %, the production amount per batch is low, which is not preferable. In addition, when the concentration of the recycled carbon black in the dispersion solvent exceeds 18 mass %, the risk of occurrence of defects such as pipe clogging during slurry production increases, which is not preferable.

As a result of intensive studies by the present inventor, it has been found that in the case of using unused carbon black instead of recycled carbon black in the step (i), when slurry is produced with the concentration of unused carbon black in the dispersion solvent set to 10 to 18 mass %, the slurry concentration is too high, and the risk of occurrence of defects such as pipe clogging during slurry production is also increased. The reason why the concentration at the time of slurry production can be set higher in the case of using recycled carbon black than in the case of using unused carbon black is not clear, but it is considered that since the recycled carbon black is partially covered with a rubber component that is not completely removed at the time of thermal decomposition, the interaction between carbon black particles is weakened as compared with the case of using unused carbon black, so that the increase in slurry viscosity can be suppressed even when the concentration at the time of slurry production is high.

In the step (i), examples of a method for producing a recycled carbon black slurry solution by dispersing the recycled carbon black in the dispersion solvent include a method of dispersing the carbon black using a general dispersing machine such as a high shear mixer, a homomixer, a ball mill, a bead mill, a high-pressure homogenizer, an ultrasonic homogenizer, and a colloid mill. In particular, in the present invention, it is preferable to use a high shear mixer in the step (i).

The “high shear mixer” is a high shear mixer equipped with a rotor including a rotating shaft and a blade, and a stator provided with a plurality of openings, and means a mixer in which a high shearing action is effected when the rotor rotates with a precise clearance provided between the rotor capable of rotating at a high speed and the fixed stator. In order to produce such a high shear action, it is preferable to set the clearance between the rotor and the stator to 0.1 to 0.3 mm. Further, in the step (i) using the high shear mixer, it is preferable to disperse the recycled carbon black in the dispersion solvent at a rate at which the dispersion solvent in a vessel of the high shear mixer circulates 5 to 25 times per minute for a dispersion treatment time of 10 to 50 minutes. As the high shear mixer, a commercially available product can be used, and examples thereof include an “in-line mixer” manufactured by Silverson.

<Step (ii)>

In the step (ii), the recycled carbon black slurry solution and a rubber latex solution are mixed to produce a recycled carbon black-containing rubber latex solution. The method for mixing the recycled carbon black slurry solution and the rubber latex solution in a liquid phase is not particularly limited, and examples thereof include a method for mixing the recycled carbon black slurry solution and the rubber latex solution using a general dispersing machine such as a high shear mixer, a homomixer, a ball mill, a bead mill, a high-pressure homogenizer, an ultrasonic homogenizer, and a colloid mill, or a mixer in which a blade rotates in a cylindrical container. The entire mixing system such as a dispersing machine may be heated, as required, during mixing.

In the method for producing a rubber wet masterbatch according to the present invention, in the step (ii), when the total amount of the rubber solid content in the rubber latex solution is taken as 100 parts by mass, the blending amount of the recycled carbon black solid content in the recycled carbon black slurry solution is set to 35 to 60 parts by mass. This makes it possible to produce a rubber wet masterbatch which is a raw material of a vulcanized rubber excellent in productivity and processability and excellent in rubber physical properties.

In the method for producing a rubber wet masterbatch according to the present invention, after the step (ii), the recycled carbon black-containing rubber latex solution is coagulated to produce a recycled carbon black-containing rubber coagulation. Examples of the coagulation method include a method in which a coagulant is incorporated into the recycled carbon black-containing rubber latex solution. In this case, as the coagulant, an acid such as formic acid and sulfuric acid, which is usually used for coagulating a rubber latex solution, or a salt such as sodium chloride can be used. After coagulating the recycled carbon black-containing rubber latex solution as described above, the obtained recycled carbon black-containing rubber coagulation is dehydrated and dried to finally produce a rubber wet masterbatch. As a method for dehydrating and drying the obtained recycled carbon black-containing rubber coagulation, for example, it is possible to dehydrate and dry the recycled carbon black-containing rubber coagulation while applying a shearing force to the recycled carbon black-containing rubber coagulation under heating to 100 to 250 °C using a single screw extruder. Before dehydration and drying, for example, centrifugal separation or a solid-liquid separation step in which a vibration screen is used may be performed for the purpose of appropriately reducing the amount of water contained in the recycled carbon black-containing rubber coagulation, or a washing step such as a water washing method may be performed for the purpose of washing, as required. In order to further dry the rubber wet masterbatch, various drying devices such as an oven, a vacuum dryer, and an air dryer can be used.

A rubber composition is produced by dry-mixing the diene-based rubber and various rubber compounding agents with the rubber wet masterbatch obtained above. Examples of usable rubber compounding agents include compounding agents usually used in the rubber industry, such as diene-based rubber, carbon black, a carbon black coupling agent, silica, a silane coupling agent, a sulfur vulcanizer, a vulcanization accelerator, an antiaging agent, zinc oxide, a methylene acceptor and a methylene donor, stearic acid, a vulcanization promotion aid, a vulcanization retarder, an organic peroxide, a softener such as wax and oil, and a processing aid.

Examples of the diene-based rubber that can be compounded with the rubber wet masterbatch, but are not limited to, natural rubber (NR), isoprene rubber (IR), butadiene-based rubber (BR), styrene-butadiene-based rubber (SBR), acrylonitrile-butadiene-based rubber (NBR), chloroprene rubber (CR), a styrene-isoprene copolymer rubber, a butadiene-isoprene copolymer rubber, and a styrene-isoprene-butadiene copolymer rubber. These diene-based rubbers may be used singly or in combination of two or more of them.

Examples of the carbon black include unused carbon black other than recycled carbon black, and more specifically, for example, carbon black usually used in the rubber industry, such as SAF, ISAF, HAF, FEF, and GPF; and conductive carbon black such as acetylene black and ketjen black can be used.

Examples of the silica to be used include silicas usually used for rubber reinforcement, such as wet silica, dry silica, sol-gel silica, and surface-treated silica. Among these, wet silica is preferred.

When silica is used in the method for producing a rubber composition according to the present invention, a silane coupling agent is preferably contained in addition to silica. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Evonik Industries AG), bis(3-triethoxysilylpropyl)disulfide (e.g., “Si75” manufactured by Evonik Industries AG), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

The sulfur as the sulfur vulcanizer is not limited as long as it is sulfur usually used for rubber, and examples of such sulfur that can be used include powdered sulfur, precipitated sulfur, insoluble sulfur, and highly-dispersible sulfur.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination.

Examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination of two or more of them.

As described above, according to the method for producing a rubber wet masterbatch of the present invention, it is possible to increase the production amount per batch while using recycled carbon black without requiring special and large-scale facilities and while reducing the risk of occurrence of defects such as pipe clogging during slurry production. Therefore, the method for producing a rubber wet masterbatch according to the present invention is excellent in productivity and processability. Furthermore, according to the method for producing a rubber composition using the rubber wet masterbatch according to the present invention as a raw material, a rubber composition which is a raw material of a vulcanized rubber excellent in physical properties such as exothermicity and fatigue resistance can be produced. For this reason, since the method for producing a rubber wet masterbatch and the method for producing a rubber composition according to the present invention use recycled carbon black, the methods are suitable for producing a raw material of a pneumatic tire in consideration of the environment, and are particularly useful when producing a member of a pneumatic tire required to have physical properties such as exothermicity and fatigue resistance, for example, tread rubber, side rubber, ply or belt coating rubber, or a raw material for bead filler rubber.

### EXAMPLES

Hereinbelow, the present invention will more specifically be described with reference to examples.

### (Raw Materials Used)

Recycled carbon black: trade name “PB-365”, manufactured by Enrestec Inc.
Rubber latex solution: (manufactured by Golden Hope Plantations Berhad)
Dispersion solvent: water.
Coagulant formic acid (primary 858, adjusted to pH 1.2 by diluting 10% solution); “manufactured by NACALAI TESQUE, INC.”
CB (FEF) (unused product): trade name “SEAST S0 (N550)”, manufactured by TOKAI CARBON CO., LTD.
CB (HAF) (unused product): trade name “SEAST KH (N339)”, manufactured by TOKAI CARBON CO., LTD.
Natural rubber: RSS #3
Zinc white: trade name “Zinc White #3”, manufactured by MITSUI MINING & SMELTING CO., LTD.
Antiaging agent 1: trade name “NOCRAC 6C”, manufactured by OUCHI SHINKO CHEMICAL INDUSTRIAL CO., LTD.
Antiaging agent 2: trade name “ANTAGE RD”, manufactured by Kawaguchi Chemical Industry Co., Ltd.
Vulcanization accelerator (NS): trade name “Sanceler NS-G”, manufactured by SANSHIN CHEMICAL INDUSTRY CO., LTD.
Sulfur: trade name “Powder Sulfur”, manufactured by Tsurumi Chemical Industry Co., ltd.

### Examples 1 to 3 and Comparative Examples 1 to 3

Recycled carbon black (or (unused) carbon black) was charged into water as a dispersion solvent so as to have the recycled carbon black (or the (unused) carbon black concentration) shown in Table 1, and the recycled carbon black (or (unused) carbon black) was dispersed in the dispersion solvent using an “in-line mixer” manufactured by Silverson that is a high shear mixer ((high shear mixer conditions) clearance between a blade and a stator of a rotor; 0.2 mm) to produce a recycled carbon black (or (unused) carbon black) slurry solution (step (i)). Table 1 shows the type of carbon black used, the concentration of recycled carbon black (unused N550 in Comparative Example 1) in the dispersion solvent (water), and the set conditions when the high shear mixer was used (circulation speed of water in a vessel of the high shear mixer (number of circulations per minute (times/min) and dispersion treatment time (min)). Further, in the (evaluation) items in Table 1, the performance of the recycled carbon black (or (unused) carbon black) slurry was evaluated according to the following criteria using the viscosity as an index.
◯; Has low viscosity and is flowable (excellent in productivity and processability)
x; Has high viscosity and is creamy and not flowable (poor in productivity and processability)

After the step (i), the recycled carbon black slurry solution and the rubber latex solution were mixed to produce a recycled carbon black-containing rubber latex solution (step (ii)). After the step (ii), formic acid as a coagulant was added to the recycled carbon black-containing rubber latex solution until the entire solution had a pH of 4, the recycled carbon black-containing rubber latex solution was coagulated, and dehydrated and dried with a squeezer type uniaxial extruding/dehydrating machine (manufactured by SUEHIRO EPM CORPORATION, screw press V-02), and the obtained coagulum was dehydrated and dried by an extruding/dehydrating machine to produce a recycled carbon black-containing rubber coagulation (rubber wet masterbatch). Table 1 shows the blending amount (parts by mass) of the recycled carbon black (or (unused) carbon black) solid content in the recycled carbon black (or (unused) carbon black) slurry solution as “Charged carbon black amount” when the total amount of the rubber solid content in the rubber latex solution is taken as 100 parts by mass. Further, in Table 1, the filling amount (parts by mass) of the recycled carbon black (or (unused) carbon black) when the total amount of the rubber component in the rubber wet masterbatch containing the recycled carbon black (or (unused) carbon black) obtained after the step (ii) is taken as 100 parts by mass is shown as “Carbon black filling amount”. The performance of the obtained rubber wet masterbatch was evaluated according to the following criteria using the coagulum size as an index.
⊚; Coagulum size of less than 40 mm
◯; Coagulum size of 40 to 100 mm
x; Coagulum size of more than 100 mm

TABLE 1

| | | Comparative | Comparative | Comparative | Example | Example | Example |
|---|---|---|---|---|---|---|---|
| | | Example 1 | Example 2 | Example 3 | 1 | 2 | 3 |
| Step | Carbon black type | (Unused | Recycled | Recycled | Recycled | Recycled | Recycled |
| (i) | | product) | carbon | carbon | carbon | carbon | carbon |
| | | N550 | black | black | black | black | black |
| | Recycled (or unused) | 9 | 15 | 20 | 15 | 15 | 15 |
| | carbon black | | | | | | |
| | concentration (%) | | | | | | |
| | Dispersion treatment | 15 | 15 | 15 | 15 | 45 | 45 |
| | time (min) | | | | | | |
| | Circulation speed of | 17 | 17 | 17 | 17 | 17 | 17 |
| | water during | | | | | | |
| | dispersion treatment | | | | | | |
| | (times/min) | | | | | | |
| | (Evaluation) Slurry | X | ◯ | X | ◯ | ◯ | ◯ |
| | performance | | | | | | |
| | (viscosity) | | | | | | |
| Step | Charged carbon black | — | 32 | — | 44 | 44 | 54 |
| (ii) | amount (parts by | | | | | | |
| | mass) | | | | | | |
| | (Evaluation) WMB | — | X | — | ◯ | ⊙ | ⊙ |
| | performance | | (300 mm or | | (30 to | (15 to | (15 to |
| | (coagulum size) | | more) | | 80 mm) | 30 mm) | 25 mm) |
| | (Evaluation) Carbon | — | — | — | 29.5 | 31.7 | 35.4 |
| | black filling amount | | | | | | |
| | (parts by mass) | | | | | | |

From the results in Table 1, in the method for producing a rubber wet masterbatch according to Comparative Example 1, even when the concentration of carbon black as an unused product was set to be as low as 9 mass %, the viscosity of the resulting slurry was high, and there was a concern about defects (pipe clogging) in production facilities, so that a rubber wet masterbatch could not be finally produced. Further, in the method for producing a rubber wet masterbatch according to Comparative Example 2, it is found that the obtained rubber wet masterbatch is aggregated, and there is a concern that there is a problem in transportation through piping, so that productivity and processability are poor. Furthermore, in the method for producing a rubber wet masterbatch according to Comparative Example 3, since the concentration of the recycled carbon black was set as high as 20 mass %, the viscosity of the obtained slurry was high, and there was a concern about defects (pipe clogging) in production facilities, so that a rubber wet masterbatch could not be finally produced. On the other hand, in the method for producing a rubber wet masterbatch according to Examples 1 to 3, it is found that the viscosity of the raw carbon black slurry solution obtained after the step (i) is sufficiently low, and the performance of the obtained rubber wet masterbatch is also excellent.

Rubber compositions according to Examples 4 to 6 were produced by dry-mixing a diene-based rubber and various rubber compounding agents with the rubber wet masterbatch obtained above. The compounding table is shown in Table 2. In Table 2, the rubber wet masterbatch produced in Example 1 was referred to as “rCBWMB1”, the rubber wet masterbatch produced in Example 2 was referred to as “rCBWMB2”, and the rubber wet masterbatch produced in Example 3 was referred to as “rCBWMB3”. The compounding ratio in Table 2 is shown in parts by mass (phr) when the total amount of the rubber component (solid content) in the rubber wet masterbatch and the natural rubber added during the production of the rubber composition is taken as 100 parts by mass. Vulcanized rubbers were produced by vulcanizing the rubber compositions according to Examples 4 to 6 at 150 °C for 25 minutes, and the exothermicity and fatigue resistance of the vulcanized rubbers were evaluated according to the following criteria.

### (Exothermicity of Vulcanized Rubbers)

In accordance with JIS K6394, a loss factor tan & was measured under the conditions of an initial strain of 10%, a dynamic strain of 18, a frequency of 10 Hz, and a temperature of 35 °C using a viscoelasticity tester manufactured by Ueshima Seisakusho Co., Ltd. An index number was determined by taking the tan δ value of Example 4 was used as 100 to evaluate exothermicity. The lower index number indicates that low exothermicity is more excellent.

### (Fatigue Resistance of Vulcanized Rubbers)

Fatigue resistance was evaluated in accordance with JIS K6260. An index number was determined by taking the result in Example 4 was used as 100 to evaluate fatigue resistance. The larger index number indicates that fatigue resistance is more excellent.

TABLE 2

| | | |
|---|---|---|
| Example 4 | Example 5 | Example 6 |

(Formulation)

| | | | |
|---|---|---|---|
| Natural rubber | 38 | 42 | 48 |
| rCBWMB1 | 84 | | |
| rCBWMB2 | | 80 | |
| rCBWMB3 | | | 74 |
| Carbon black (HAF) | 12.5 | 12.5 | 12.5 |
| Zinc white | 3.5 | 3.5 | 3.5 |
| Antiaging agent 1 | 0.8 | 0.8 | 0.8 |
| Antiaging agent 2 | 0.4 | 0.4 | 0.4 |
| Vulcanization accelerator (NS) | 1.4 | 1.4 | 1.4 |
| Sulfur | 1.8 | 1.8 | 1.8 |

(Evaluation of vulcanized rubber)

| | | | |
|---|---|---|---|
| Exothermicity | 100 | 101 | 104 |
| Fatigue resistance | 100 | 105 | 126 |

From the results in Table 2, it is found that the vulcanized rubbers of the rubber compositions according to Examples 4 to 6 are all excellent in exothermicity and fatigue resistance, and therefore the rubber compositions according to Examples 4 to 6 can be raw materials of vulcanized rubbers excellent in rubber physical properties.

What is claimed is:

1. A method for producing a rubber wet masterbatch using at least recycled carbon black, a dispersion solvent, and a rubber latex solution as raw materials, the method comprising:
a step (i) of dispersing the recycled carbon black in the dispersion solvent to produce a recycled carbon black slurry solution; and
a step (ii) of mixing the recycled carbon black slurry solution and the rubber latex solution to produce a recycled carbon black-containing rubber latex solution,
wherein
in the step (i), a concentration of the recycled carbon black in the dispersion solvent is set to 10 to 18 mass %, and
in the step (ii), when a total amount of the rubber solid content in the rubber latex solution is taken as 100 parts by mass, a blending amount of the recycled carbon black solid content in the recycled carbon black slurry solution is set to 35 to 60 parts by mass.

2. The method for producing a rubber wet masterbatch according to claim 1, wherein the step (i) is performed using a high shear mixer including a rotor including a rotating shaft and a blade, and a stator provided with a plurality of openings.

3. The method for producing a rubber wet masterbatch according to claim 2, wherein the step (i) is a step of dispersing the recycled carbon black in the dispersion solvent using the high shear mixer by setting a clearance between the blade of the rotor and the stator to 0.1 to 0.3 mm.

4. The method for producing a rubber wet masterbatch according to claim 2, wherein the step (i) is a step of dispersing the recycled carbon black in the dispersion solvent using the high shear mixer at a rate at which the dispersion solvent in a vessel of the high shear mixer circulates 5 to 25 times per minute for a dispersion treatment time of 10 to 50 minutes.

5. The method for producing a rubber wet masterbatch according to claim 1, comprising, after the step (ii), a step of coagulating the recycled carbon black-containing rubber latex solution to produce a recycled carbon black-containing rubber coagulation.

6. The method for producing a rubber wet masterbatch according to claim 5, comprising a step of finally producing a rubber wet masterbatch by dehydrating and drying the recycled carbon black-containing rubber coagulation.

7. The method for producing a rubber wet masterbatch according to claim 6, comprising a step of finally producing a rubber wet masterbatch by dehydrating and drying the recycled carbon black-containing rubber coagulation while applying a shearing force to the recycled carbon black-containing rubber coagulation under heating to 100 to 250 °C using a single screw extruder.

8. A method for producing a rubber composition comprising mixing a rubber wet masterbatch and a compounding agent, wherein
the rubber wet masterbatch is produced by the method for producing a rubber wet masterbatch according to claim 1.
